(19) United States
(12) Patent Application Publication
(10) Pub. No.: US 2026/0350410 A1
(43) Pub. Date: Nov. 5, 2026

(54) METHOD AND DEVICE FOR LEARNING IMAGE PROCESSING USING KNOWLEDGE DISTILLATION

(71) Applicants: Hyundai Motor Company, Seoul (KR); Kia Corporation, Seoul (KR)

(72) Inventor: Jong Hyun CHOI, Hwaseong-Si (KR)

(21) Appl. No.: 19/395,806

(22) Filed: Nov. 20, 2025

(30) Foreign Application Priority Data
Dec. 17, 2024 (KR) 10-2024-0188423

(51) Int. Cl. G06N 3/096; G06N 3/0455; G06V 10/77; G06V 10/82

(52) U.S. Cl. CPC G06N 3/096; G06N 3/0455; G06V 10/7715; G06V 10/82

(57) ABSTRACT

Aspects described herein relate to a method and device for learning image processing using knowledge distillation. The method may include: training a teacher model having a learning network that generates three-dimensional (3D) recognition data for recognizing an object three-dimensionally based on image data of an image sensor and three-dimensional sensor data of a three-dimensional recognition sensor different from the image sensor; and/or training a student model having a learning network that generates 3D recognition data based on the image data by the knowledge distillation of the teacher model.

### CROSS-REFERENCE TO RELATED APPLICATION

This application claims priority to and the benefit of Korean Patent Application No. 10-2024-0188423, filed on Dec. 17, 2024, the disclosure of which is incorporated herein by reference in its entirety.

### FIELD

The present disclosure relates to a method and device for learning image processing using knowledge distillation. For example, aspects described herein relate to an image sensor-based learning network having the same performance as a high-performance learning network that recognizes objects by fusing an image sensor and a three-dimensional (3D) recognition sensor and constructing an image-based learning network that relies only on an image sensor.

### BACKGROUND

Some vehicles may provide various functions for driving convenience. To this end, autonomous driving functions and/or manual driving support functions are supported by vehicles. Some autonomous driving functions are being developed to realize full autonomous driving, where a vehicle completely controls driving without driver intervention in any situation. Before the transition to full autonomous driving, some functions of the autonomous driving may be equipped and utilized in commercially-available vehicles. For example, in some circumstances, manual driving of a vehicle may be supported via display of the environment around the vehicle may be as an image (e.g., to help a user to drive on a road and/or park the vehicle).

In some autonomous driving schemes, the vehicle may recognize the surrounding environment acquired by the sensor, acquire various types of data from the inside and outside of the vehicle, and/or identify situations around the vehicle based on the recognized surrounding environment and data. The vehicle may establish a control plan for autonomous driving in response to the identified situations, and control actuators of the vehicle and/or provide information for manual driving.

To this end, vehicles with autonomous driving features may include a computing device executing a model for processing images for recognizing the surrounding environment. For accurate recognition, multiple cameras may be mounted on various sites of the vehicle, and the vehicle may generate multi-view images, such as surround view images, that might be acquired from multiple cameras and may visually represent the entire environment around the vehicle.

Camera-based 3D object recognition technology may be widely used in autonomous vehicles, but it may be difficult to directly acquire three-dimensional (3D) information from two-dimensional (2D) images. In contrast, since 3D recognition sensors, such as a LiDAR sensor, directly output 3D sensor data, data of the LiDAR sensor may have excellent performance in identifying 3D object information. However, LiDAR sensors might not be utilized in actual vehicles due to its high cost. Accordingly, data of a LiDAR sensor may be utilized as training data in training an image-based learning network that relies only on an image sensor, so that the image-based learning network may generate 3D recognition data based on 2D images acquired from the image sensor. However, the image-based learning network trained by simply using the data of the LiDAR sensor as training data may have low performance.

### SUMMARY

According to one or more aspects of the present disclosure, a method and device for learning image processing for providing an image sensor-based learning network are provided. One of the many advantages of this approach may be that the learned images processing may have the same performance as a high-performance learning network by, for example, distilling a high-performance learning network that recognizes objects by fusing an image sensor and a three-dimensional (3D) recognition sensor and constructing an image-based learning network that relies only on an image sensor.

The technical problems of the present disclosure are not limited to the above-described technical problems. That is, other technical problems that are not described may be obviously understood by those skilled in the art to which the present disclosure pertains from the following description.

Aspects described herein relate to a method of learning image processing using knowledge distillation, the method comprising: training a teacher model having a learning network that generates three-dimensional (3D) recognition data for recognizing an object three-dimensionally based on image data of an image sensor and three-dimensional sensor data of a three-dimensional recognition sensor different from the image sensor; and/or training a student model having a learning network that generates 3D recognition data based on the image data by the knowledge distillation of the teacher model. The teacher model may be trained to generate a teacher 3D recognition feature based on a fused feature based on a feature of the image data and a feature of the 3D sensor data and decode the teacher 3D recognition feature to generate the 3D recognition data. Also, the student model may be trained to generate a student 3D recognition feature based on a student image feature of the image data and decode the student 3D recognition feature to generate the 3D recognition data. In addition, the training of the student model includes training the student model using a first loss between the fused feature and the student image feature and a second loss between the teacher 3D recognition feature and the student 3D recognition feature.

According to some examples of the present disclosure, a dimension of the fused feature may be set to be the same as a dimension of the student image feature.

According to some examples of the present disclosure, the 3D sensor data may be preprocessed to arrange point information of the 3D sensor data to a position occupied in a 2D space centered on a device in which the image sensor may be mounted and encode data that may be not provided in the 2D image data among the point information to the position.

According to some examples of the present disclosure, the feature of the image data may be generated to be mapped to the 2D space by a geometric parameter of the image sensor. According to some examples of the present disclosure, the student image feature may be extracted using an encoder having lower performance than an encoder that generates the feature of the image data.

According to some examples of the present disclosure, the student image feature may be generated to be mapped to the same space as a 2D space occupied by the 3D sensor data by a geometric parameter of the image sensor.

According to some examples of the present disclosure, the training of the student model may include transferring a decoder that decodes the teacher 3D recognition feature to a decoder that decodes the student 3D recognition feature.

According to some examples of the present disclosure, the first loss may be established based on an identity between the fused feature and the student image feature, and the second loss may be established based on an identity between the teacher 3D recognition feature and the student 3D recognition feature.

According to some examples of the present disclosure, the method may further comprise, after the training of the student model, performing fine tuning on the student model. The performing of the fine tuning may include processing the fine tuning using labeled ground truth data and pseudo ground truth data, the labeled ground truth data may be provided to be labeled in a format of the 3D recognition data, and the pseudo ground truth data may be the 3D recognition data generated to be labeled by the teacher model. Also, a loss used for the fine tuning by the pseudo ground truth data may be set to be less than a loss of the fine tuning by the labeled ground truth data.

According to the example of the present disclosure, the 3D recognition sensor may include at least one of a LiDAR sensor, a radar sensor, and/or an ultrasonic sensor.

According to some examples of the present disclosure, there may be provided a device for learning image processing using knowledge distillation, the device comprising: a memory storing at least one instruction; and/or at least one processor that executes the at least one instruction stored in the memory. The at least one processor may be configured to train a teacher model having a learning network that generates three-dimensional recognition data for recognizing an object three-dimensionally based on image data of an image sensor and three-dimensional sensor data of a three-dimensional recognition sensor different from the image sensor, and train a student model having the learning network that generates 3D recognition data based on the image data by the knowledge distillation of the teacher model. The teacher model may be trained to generate a teacher 3D recognition feature based on a fused feature based on a feature of the image data and a feature of the 3D sensor data and decode the teacher 3D recognition feature to generate the 3D recognition data. The student model may be trained to generate a student 3D recognition feature based on a student image feature of the image data and decode the student 3D recognition feature to generate the 3D recognition data. Also, the training of the student model includes training the student model using a first loss between the fused feature and the student image feature and a second loss between the teacher 3D recognition feature and the student 3D recognition feature.

The features briefly summarized above for this disclosure are only illustrative aspects of the detailed description of the disclosure which follow, and are not intended to limit the scope of the disclosure.

### BRIEF DESCRIPTION OF THE DRAWINGS

The above and other objects, features and advantages of the present invention will become more apparent to those of ordinary skill in the art by describing illustrative examples thereof in detail with reference to the accompanying drawings, in which:

FIG. 1 may be a schematic diagram illustrating modules that constitute a device for learning image processing;

FIG. 2 may be a flowchart illustrating a method of learning image processing using knowledge distillation;

FIG. 3 may be a schematic diagram illustrating a process of training a student model by knowledge distillation of a teacher model;

FIG. 4 may be a diagram illustrating a vehicle communicating with other devices to transmit and receive data; and

FIG. 5 may be a diagram schematically illustrating modules that constitute a vehicle.

### DETAILED DESCRIPTION OF ILLUSTRATIVE EXAMPLES

Hereinafter, illustrative examples of the present disclosure will be described in detail with reference to the accompanying drawings so that those skilled in the art may easily implement the present disclosure. However, the present disclosure may be implemented in various different ways, and may be not limited to the examples described therein.

In describing illustrative examples of the present disclosure, the same constituent elements in the drawings are denoted by the same reference numerals, and a repeated description of the same elements will be omitted.

In the present disclosure, when an element may be simply referred to as being “connected to,” “coupled to,” and/or “linked to” another element, this may mean that an element may be “directly connected to,” “directly coupled to,” and/or “directly linked to” another element or may be connected to, coupled to, and/or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples may be included in the scope of the present disclosure.

In the present disclosure, elements described in various examples do not necessarily mean essential elements, and some of them may be optional elements. Therefore, an example composed of a subset of elements described in an example may be also included in the scope of the present disclosure. In addition, examples including other elements in addition to the elements described in the various examples are also included in the scope of the present disclosure.

The advantages and features of the present invention and the way of attaining them are illustrated via various examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the invention to those skilled in the art.

In the present disclosure, each of phrases such as “A or B”, “at least one of A and B,” “at least one of A or B,” “A, B or C,” “at least one of A, B and C,” “”at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper,” “lower,” “left,” and/or “right” are employed for the convenience of explanation, and in case drawings illustrated in the present specification are inversed, the location relations described in the specification may be inversely understood.

Hereinafter, examples of the present disclosure will be described with reference to the accompanying drawings.

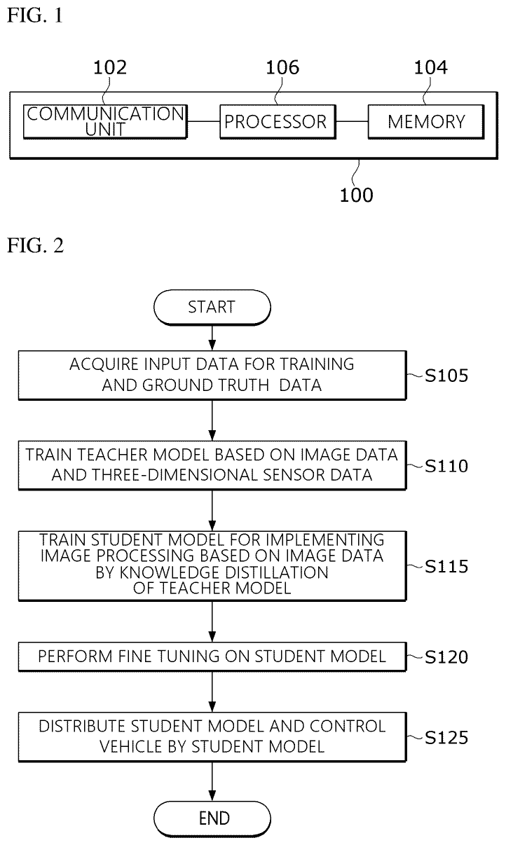

Hereinafter, referring to FIG. 1, a learning device for performing a method of learning image processing using knowledge distillation according to an example of the present disclosure will be described. FIG. 1 may be a diagram schematically illustrating modules that constitute a device for learning image processing according to an example of the present disclosure.

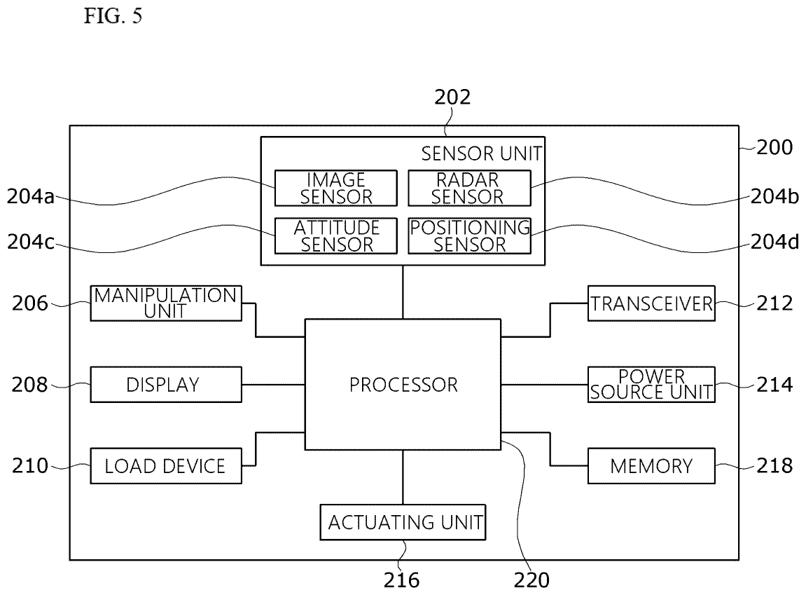

Referring to FIG. 1, a learning device 100 may train a teacher model having a learning network that generates three-dimensional recognition data for recognizing an object three-dimensionally based on image data of an image sensor and three-dimensional sensor data of a three-dimensional recognition sensor different from the image sensor. The learning device 100 may construct an image-based image processing model that relies only on an image sensor by training a student model having a learning network that generates three-dimensional recognition data based on the image data by knowledge distillation of the teacher model. The learning device 100 distributes the trained image-based image processing model to other devices, such as a vehicle (200 and 400 of FIG. 5; hereinafter, referred to as 200 for convenience of description), so that the vehicle 200 may utilize the distributed image-based image processing model to control the vehicle, such as controlling a driving or parking operation.

The image sensor and the 3D recognition sensor may be mounted on, for example, a device that acquires training data. A plurality of image sensors may be mounted on multiple sites on the device. Accordingly, the image data utilized in the teacher model and the student model may be related to a surrounding environment acquired as a two-dimensional (2D) image from the plurality of image sensors. The device may be a movable device, such as a vehicle or a robot.

The 3D recognition sensor may be a sensor different from the image sensor and may output 3D sensor data that recognizes the environment around the device in three dimensions. The 3D sensor data may output, for example, a point set that acquires an object in the surrounding environment in three dimensions. The point set may be point cloud data including a plurality of mutually spaced points for detecting an object. The points may be in the form of points or short lines. The 3D recognition sensor may include, for example, at least one of a LiDAR sensor, a radar sensor, or an ultrasonic sensor. One example of the 3D recognition sensor may be a LiDAR sensor.

The teacher model may use the image data and the 3D recognition data as the training data and input, and the student model might use only the image data as the training data and input, but both the teacher model and the student model may generate 3D recognition data. The teacher model and the student model may be networks related to tasks for generating 3D recognition data, such as object detection, semantic segmentation, depth information, and end-to-end autonomous driving based on object recognition. The teacher model and the student model are not limited thereto and may be various training models for driving assistance. In the present disclosure, the teacher model and the student model (and/or image-based image processing model) are illustrated as processing an object recognition task.

The 3D recognition data may be generated to represent the surrounding environment detected from the plurality of image sensors as a bird's eye view (BEV) image, and to recognize an object in three dimensions from the bird's eye view image. The 3D recognition data may be, for example, the BEV. In addition, the 3D recognition data may be generated to identify the type or class of each object while distinguishing each object by a 3D boundary area surrounding the object, for example, a 3D bounding box.

The vehicle 200 that receives the image-based image processing model corresponding to the student model from the learning device 100 may refer to a movable device. The vehicle 200 may be a ground vehicle that travels on the ground, and may be a typical passenger or commercial vehicle, a purpose-built vehicle (PBV), etc. The vehicle 200 may be a robot in a broad sense, such as a means of transportation, and the robot may be moved using wheels, tracks, or other movement modules. The vehicle 200 may be driven autonomously or manually.

The autonomous vehicle 200 may be implemented with semi-autonomous driving or fully autonomous driving. The fully autonomous driving may be provided as autonomous movement in which the vehicle 200 completely controls the operation without driver intervention, even in uncertain driving situations. The semi-autonomous driving may be provided as autonomous movement that requires driver intervention depending on a specific driving situation.

The semi-autonomous driving may be implemented such that the vehicle 200 deactivates autonomous driving upon the occurrence of the above situations and transfers control to a user, thereby enabling the user to perform manual driving. According to the level of the autonomous driving defined by the Society of Automotive Engineers (SAE), the semi-autonomous driving may correspond to autonomous driving levels 1 to 4, and the fully autonomous driving corresponds to level 5. The image-based image processing model constructed by the present disclosure may be not only applicable to the vehicle 200 for traveling on the ground, but may be applied to various transportation devices such as, for example, an air mobility device, a water mobility device for water transportation, or an underwater mobility device (for example, a submarine).

The learning device 100 may be, for example, a device, such as a server, provided separately from the vehicle 200 to be operated by a vehicle manufacturer or a management agency providing autonomous driving services. When the learning device 100 may be a server operated by the vehicle manufacturer or the management agency supporting autonomous driving, it may receive connected data of the vehicle 200 or transmit data necessary for autonomous driving. In order to support the autonomous driving and various services of the vehicle 200, the learning device 100 may transmit various types of information and software modules used for controlling the vehicle 200 to the vehicle 200 in response to requests and data transmitted from the vehicle 200 and the user device. In the present disclosure, the functions of the learning device 100 related to the learning method according to the example will be mainly described.

The learning device 100 may include a communication unit 102, a memory 104, and a processor 106. The communication unit 102 may support mutual communication with the vehicles 200 and 400, an intelligent transportation system (ITS) device 300, etc. The communication unit 102 may comprise a communication interface that receives various types of data and a learning network used for training a learning network supporting driving and convenience functions of the vehicle 200, and/or that transmits information related to the learning network and the learning network to the vehicle 200. The learning network may be referred to as a network, a training model, or a model.

In addition, the communication unit 102 may be a communication module that receives data generated or stored during driving from the vehicle 200 and/or transmits information supporting driving, such as map information, environmental information recognizing objects around the vehicle 200, traffic information, weather information, etc., to the vehicle 200. The communication unit 102 may comprise a communication module that transmits applications related to driving and convenience functions.

The memory 104 may store a program and various types of data for controlling the learning device 100, and may load a program or read and record data at the request of the processor 106. The memory 104 may hold input data for training and ground truth data that are provided to construct the teacher model and the student model. The memory 104 may manage data related to the trained teacher model and the student model (the image-based image processing model) constructed by knowledge distillation.

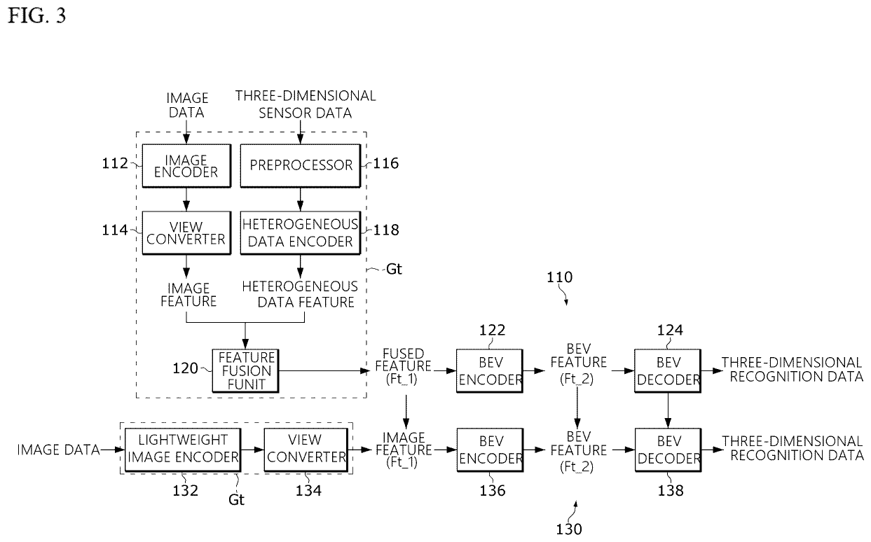

The teacher model and the student model are models may be related to reference numerals 110 and 130 in FIG. 3, which will be described below, respectively, and each of the teacher model and the student model may include the functional modules in FIG. 3. The input data for training may include the image data and the 3D sensor data collected from the plurality of vehicles 200 and 400 and/or a typical training data DB. The 3D sensor data may be, for example, point cloud data of the LiDAR sensor. The ground truth data may be data generated by associating the image data with the 3D sensor data and may be labeled 3D recognition data. The ground truth data may be, for example, data related to a BEV that recognizes objects three-dimensionally. The labeled 3D recognition data may be formed in the format of a BEV image including a 3D bounding box and a class.

The 3D recognition data may be generated to represent the surrounding environment detected from the plurality of image sensors as a bird's eye view image, and to recognize an object in three dimensions from the bird's eye view image. The 3D recognition data may be, for example, a BEV. In addition, the 3D recognition data may be generated to identify the type or class of each object while distinguishing each object by a 3D boundary area surrounding the objects, for example, a 3D bounding box. The data related to the model may include, for example, parameters and other information established by training the model.

In addition to the data described above, the memory 104 may also hold applications for implementing driving and convenience functions of the vehicle 200, map information, traffic information, weather information, and other various types of information affecting driving.

The processor 106 may perform overall control of the learning device 100. The processor 106 may be configured to execute applications and instructions stored in the memory 104. The processor 106 may execute a process of training the teacher model having a learning network that generates dimensional recognition data using the input data for training and the ground truth data. The processor 106 may perform processing to train the student model having the learning network that generates the 3D recognition data based on the image data by the knowledge distillation of the teacher model, thereby generating an image processing model that relies only on the image sensor. A detailed description of the training of the teacher model by the processor 106 and the training of the student model by knowledge distillation will be described below.

The processor 106 may perform processing to support the driving and convenience functions of the vehicle 200. In the present disclosure, the processor 106 may, for example, be implemented as a single processing module. In another example, the processing according to the above-described matters may be distributed and processed in a plurality of processing modules, and the processor 106 may be collectively referred to as a plurality of processing modules in the present disclosure.

Hereinafter, a learning method of depth estimation based on view synthesis according to another example of the present disclosure will be described in detail with reference to FIGS. 2 and 3.

FIG. 2 is a flowchart illustrating a method of learning image processing using knowledge distillation according to an example of the present disclosure. FIG. 3 is a diagram schematically illustrating the process of training the student model by the knowledge distillation of the teacher model. The functional modules of each model illustrated in FIG. 3 may be software modules.

In the present disclosure, the model according to the example may be mainly described as being trained only in the learning device 100, but the method of learning image processing described below may be distributed and processed in the learning device 100 and other devices within the scope that does not conflict with the description below. The other devices may be, for example, other servers and/or vehicles 200 and 400. Hereinafter, the processor 106 of the learning device 100 may be abbreviated as the learning device 100 for convenience of description, or these terms may be used interchangeably.

Referring to FIG. 2, the learning device 100 may acquire the input data for training and the ground truth data used for training the teacher model and the student model (S105).

The input data for training may be the image data of the image sensor and the 3D sensor data of the 3D recognition sensor, as described in FIG. 1. The image data may be, for example, an image of the surrounding environment acquired from the plurality of image sensors mounted on the device. In the present disclosure, the modules related to the processing of the image data in each operation of FIGS. 2 and 3 are exemplified as processing the image data for each of the plurality of image sensors.

The 3D recognition sensor may include, for example, at least one of a LiDAR sensor, a radar sensor, and/or an ultrasonic sensor. The 3D sensor data may include information that recognizes the environment around the device in three dimensions, and the detailed description may be substantially the same as that described in FIG. 1. In the present disclosure, for convenience of description, the 3D recognition sensor may comprise a LiDAR sensor. In the case of the LiDAR sensor, the 3D sensor data may include the point cloud data and/or other types of information.

The ground truth data may be data generated by associating the image data with the point cloud data and may be labeled 3D recognition data. In the present disclosure, the ground truth data may be, for example, data related to a BEV that recognizes objects three-dimensionally. The labeled 3D recognition data may be formed in the format of a BEV image including a 3D bounding box and a class.

Next, the processor 106 of the learning device 100 may train the teacher model having the learning network that generates the 3D recognition data based on the image data and the 3D sensor data (S110).

Referring to FIG. 3, the teacher model 110 may be trained to generate image features and 3D features based on the image data and the 3D sensor data, respectively, generate fused features associated with each feature, and output the 3D recognition data based on the fused features. In the present disclosure, the image features may be referred to as teacher image features to be distinguished from the image features of the student model 130. The teacher model 110 may be constructed to have detailed function modules 112 to 124 for implementing the above-described functions, as illustrated in FIG. 3.

For example, the teacher model 110 may include an image encoder 112, a view converter 114, a preprocessor 116, a heterogeneous data encoder 118, and/or a feature fusion unit 120.

The image encoder 112 may extract features from the image data acquired as two-dimensional (2D) images of objects in the surrounding environment by each of the plurality of image sensors. In the present disclosure, for convenience of description, the features generated by the image encoder 112 of the teacher model 110 may be referred to as teacher feature information.

The image encoder 112 may be formed with, for example, an encoder structure of a convolutional neural network (CNN). The image encoder 112 may include convolutional layers, filters, and various functional units for extracting teacher feature information. The parameters of the filters in the image encoder 112 and the factors of the units may be learnable parameters.

The image encoder 112 may have higher performance than a lightweight image encoder 132 of the student model 130 described below. The image encoder 112 of the teacher model 110 may be provided to, for example, output a high-dimensional feature map compared to the lightweight image encoder 132, and/or to have higher filter performance compared to the lightweight image encoder 132, a larger number of convolutional layers compared to the lightweight image encoder 132, a smaller stride compared to the lightweight image encoder 132, etc.

The view converter 114 may generate the teacher image features by mapping teacher feature information into a predetermined two-dimensional space by geometric parameters of each image sensor.

The geometric parameters may be provided for each of the plurality of image sensors. The geometric parameters may include internal geometric parameters and external geometric parameters. The internal geometric parameters may comprise intrinsic factors unique to the image sensor, and may include, but are not limited to, focal length, principal point, lens curvature, and/or resolution. The external geometric parameters may be attitude data of each image sensor mounted on the device. The external geometric parameters may include, for example, the position and direction (or shooting direction) of each image sensor with respect to the device.

The predetermined two-dimensional space may comprise a space having a two-dimensional coordinate system centered on a device equipped with the plurality of image sensors. When the device may be a vehicle, the center of the two-dimensional space may be a predetermined point of the vehicle. The two-dimensional space may be a two-dimensional voxel space in which spatial alignment with three-dimensional sensor data, for example, the point cloud data of the LiDAR sensor, may be matched.

The view converter 114 may generate the teacher image features by projecting the teacher feature information into the two-dimensional space based on the geometric parameters of each image sensor and the two-dimensional coordinate system centered on the device.

The preprocessor 116 may arrange the three-dimensional sensor data that three-dimensionally acquires objects of the surrounding environment into the two-dimensional space described above and may encode data that may be not provided in the two-dimensional image data into the two-dimensional space. The preprocessor 116 may, for example, arrange point information included in the point cloud data of the LiDAR sensor at a position occupied in the two-dimensional space. The point information may be information about a point that appears as the detection of an object, and may have three-dimensional coordinates, for example, x, y, and z values. The point may also be referred to as a LiDAR point. The LiDAR point may be positioned in a corresponding two-dimensional voxel space in the two-dimensional space. In addition, the two-dimensional image data and the two-dimensional space are provided to have the x, y values, so the z value of the LiDAR point that may be not provided in the image data and the two-dimensional space may be encoded in the two-dimensional voxel space where the point may be positioned.

The heterogeneous data encoder 118 may extract heterogeneous data features from preprocessed 3D sensor data. In the present disclosure, the heterogeneous data features may be considered as features of the 3D sensor data. The heterogeneous data encoder 118 may be formed with, for example, an encoder structure of a CNN. The heterogeneous data encoder 118 may include convolutional layers, filters, and various functional units for extracting feature information. The parameters of the filters in the heterogeneous data encoder 118 and the factors of the unit may be learnable parameters. The heterogeneous data encoder 118 may utilize a high-performance CNN encoder for accurate feature extraction.

The feature fusion unit 120 may generate fused features based on the teacher image features and the heterogeneous data features. For easy distillation of the fused features for the student model 130, the dimension of the fused features may be set to be the same as the dimension of the student image features generated in the view converter 114 of the student model 130 described below. The fused feature may be a kind of knowledge of the teacher model 110 that may be distilled to the student model 130.

For example, when the heterogeneous data features are data of a LiDAR sensor, the feature fusion unit 120 may utilize the external geometric parameters for each of the plurality of image sensors to map the teacher image features to the same space as the LiDAR voxels. After the teacher student features and heterogeneous data features in the voxel are concatenated in the channel direction, the concatenated features may be passed to a feature channel former composed of a convolutional layer. The number of input channels of the feature channel former may be the number of channels of the teacher model 110, and the number of output channels of the feature channel generator may be the number of channels of the student model 130. Accordingly, features having all information related to the image and the LiDAR data and having the same dimension (or size) as the student model 130 may be extracted. The factors involved in the feature channel former of the feature fusion unit 120 may be the learnable parameters.

The teacher model 110 may include a BEV encoder 122 and a BEV decoder 124. In the present disclosure, it may be described as an example that the BEV may be generated based on the image data of the plurality of image sensors to recognize an object in three dimensions. The BEV encoder 122 and the BEV decoder 124 may be modules that generate the bird's-eye view image for three-dimensionally identifying an object based on the fused features. Therefore, the BEV encoder 122 and the BEV decoder 124 are examples of an encoder and a decoder for generating 3D recognition data, and the encoder and the decoder for 3D recognition data are not limited to the examples described above and may be implemented in various ways. Hereinafter, for convenience of description, the BEV encoder 122 and the BEV decoder 124 are described as examples of an encoder and a decoder for 3D recognition data.

The BEV encoder 122 may generate BEV features based on the fused features. In the present disclosure, the BEV features are referred to as teacher 3D recognition features to distinguish the teacher 3D recognition features from the BEV features of the student model 130 described below, and the BEV features of the student model 130 may be referred to as student 3D recognition features. The BEV encoder 122 may include, for example, convolutional layers, filters, and various functional units for feature extraction. The factors used in the filters and other functional units may be learnable parameters.

The BEV decoder 124 may decode the teacher 3D recognition features to generate 3D recognition data. For example, the 3D recognition data may be generated to have a 3D bounding box and/or a class as described above. For example, the BEV decoder 124 may output multi-view image data that recognizes objects three-dimensionally based on the teacher 3D recognition features, for example, the BEV features, by upsampling convolution using a predetermined filter. The factors of the filter, the factors utilized in the unit for generating the multi-view image, the factors applied to the unit for recognizing the object, and the factors utilized in the layers of various functions may be learnable parameters.

The processor 106 of the learning device 100 may train the teacher model 110 using a loss function between the 3D recognition data generated by processing the image data and the 3D sensor data through the modules described above in the teacher model 110 and the ground truth data. For example, the learnable parameters described above may be determined by training the teacher model 110. The processor 106 may determine the learnable parameters of the teacher model 110 to construct the teacher model 110 when the value of the loss function may be less than or equal to a threshold value or converges to a predetermined value range. The teacher model 110 may be constructed by learning a large amount of image data, 3D sensor data having accurate 3D information, and a module having high-performance feature extraction, so that the high-performance teacher model 110 may be constructed.

Referring back to FIG. 2, the processor 106 of the learning device 100 may train the student model 130 that generates 3D recognition data based on image data by the knowledge distillation of the teacher model 110 (S115).

Before describing the knowledge distillation, the student model 130 will be described. As described above, the student model 130 may be an image processing network that generates 3D recognition data based on image data by relying only on the image sensor.

Referring to FIG. 3, the student model 130 may be constructed to include the lightweight image encoder 132, the view converter 134, a BEV encoder 136, and/or a BEV decoder 138. The BEV encoder 136 and the BEV decoder 138 may be examples of an encoder and a decoder for generating 3D recognition data from substantially the same perspective as the teacher model 110. The encoder and the decoder for 3D recognition data are not limited to the examples described above and may be implemented in various ways. Hereinafter, for convenience of description, the BEV encoder 136 and the BEV decoder 138 are described as examples of an encoder and a decoder for 3D recognition data.

The lightweight image encoder 132 may extract features from image data acquired as 2D images of the objects in the surrounding environment by each of the plurality of image sensors. In the present disclosure, for convenience of description, the features generated by the lightweight image encoder 132 of the student model 130 may be referred to as student feature information.

The lightweight image encoder 132 may be formed with, for example, an encoder structure of a CNN. The lightweight image encoder 132 may include convolutional layers, filters, and various functional units for extracting the student feature information. The parameters of the filters in the lightweight image encoder 132 and the factors of the units may be learnable parameters.

The image encoder 132 may have a lower performance than the image encoder 112 of the teacher model 110. The lightweight image encoder 132 may be provided to output a lower dimensional feature map than the image encoder 112, to have lower filter performance than the image encoder 112, to have a smaller number of convolutional layers than the image encoder 112, or to have a larger stride than the image encoder 112.

The view converter 134 may generate image features by mapping student feature information into a predetermined two-dimensional space by the geometric parameters of each image sensor. In the present disclosure, the image features may be referred to as student image features to distinguish the student image features from the image features of the teacher model 110.

The geometric parameters may be provided for each of the plurality of image sensors. The geometric parameters may include the internal geometric parameters and the external geometric parameters. A detailed description thereof may be described in the teacher model 110 and therefore will be omitted.

The predetermined two-dimensional space may be a space having a two-dimensional coordinate system centered on the device equipped with the plurality of image sensors. As described for the teacher model 110, when the device may be a vehicle, the center of the two-dimensional space may be a predetermined point of the vehicle. The two-dimensional space may comprise the two-dimensional voxel space described for the teacher model 110. Accordingly, the student image features may be generated to be mapped to the same two-dimensional space occupied by the 3D sensor data in the teacher model 110.

The view converter 134 may generate the student image features by projecting the student feature information into the two-dimensional space based on the geometric parameters of each image sensor and the two-dimensional coordinate system centered on the device.

The BEV encoder 136 may generate BEV features based on the student image features. In the present disclosure, the BEV features may be referred to as student 3D recognition features. The BEV encoder 136 may include, for example, convolutional layers, filters, and various functional units for feature extraction. The factors used in the filters and other functional units may be learnable parameters. Since the BEV encoder 136 of the student model 130 uses the student image features that rely only on image data, it may have a different structure from the BEV encoder of the teacher model 110 that uses fused features that fuses teacher image features and heterogeneous data features.

The BEV decoder 138 may decode the student 3D recognition features to generate 3D recognition data. For example, the 3D recognition data may be generated to have a 3D bounding box and a class as described above. For example, the BEV decoder 138 may output multi-view image data that recognizes objects three-dimensionally based on the teacher 3D recognition features, i.e., the BEV features, by upsampling convolution using a predetermined filter. The factors of the filter, the factors utilized in the unit for generating the multi-view image, the factors applied to the unit for recognizing the object, and the factors utilized in the layers of various functions may be the learnable parameters.

Since the student 3D recognition features and the teacher 3D recognition features input to the BEV decoder 138 of the student model 130 and the BEV decoder 124 of the teacher model 110 have the same data structure, the two decoders 124 and 138 may have the same structure. According to the example of FIG. 3, the BEV features output from the BEV encoder 124 and the BEV decoder 138 may have the same format.

The training of the student model 130 by knowledge distillation will be described. The student model 130 may be trained to generate student 3D recognition features based on the student image features of the image data by the knowledge distillation of the teacher model 110 and decode the student 3D recognition features to generate 3D recognition data.

By transferring the BEV decoder 124 to the BEV decoder 138 in the training of the student model 130, the BEV decoder 138 of the student model 130 may be constructed to have the same structure as the BEV decoder 124 of the teacher model 110.

Thereafter, the processor 106 of the learning device 100 may train the student model 130 using a first loss between a fused feature Ft_1 and a student image feature Fs_1 and a second loss between a teacher 3D recognition feature (teacher BEV feature; Ft_2) and a student 3D recognition feature (student BEV feature; Fs_2). Here, the loss may be an abbreviated term for loss function. The threshold values for the first and second loss functions may be randomly set. For example, the first loss function may be established based on the identity between the fused feature Ft_1 and the student image feature Fs_1. The first loss function may be, for example, mean |Ft_1−Fs_1|. The second loss function may be established based on an identity between the teacher 3D recognition feature Ft_2 and the student 3D recognition feature Fs_2.

One training goal of the student model 130 may be to train the student model so that the 3D recognition data of the teacher model 110 and the student model 130 are identical. In the present disclosure, by transferring the BEV decoder 124 to the BEV decoder 138, when the fused feature Ft_1 and the student image feature Fs_1 are identical, and the teacher 3D recognition feature Ft_2 and the student 3D recognition feature Fs_2 are identical, the 3D recognition data of the teacher model 110 and the student model 130 may be generated identically.

The processor 106 of the learning device 100 may train the student model 130 using first and second loss functions while distilling knowledge (and/or features) from the teacher model 110 into the student model 130. By training the student model 130, the learnable parameters described above in relation to the student model 130 may be determined. When the values of the first and second loss functions satisfy a predetermined condition, the processor 106 may determine the learnable parameters of the student model 130 to construct the student model 130.

According to the present disclosure, the lightweight student model 130 may be trained to have the same performance as the high-performance teacher model 110 based on the 3D sensor data without inputting data of the 3D recognition sensor.

In addition, since the knowledge distillation method based on 3D recognition data, which may be the final output of the teacher model 110 and the student model 130, uses excessive layers compared to the present example, the performance and quality of the student model 130 trained based on distillation may be lower than that of the teacher model 110. As in the present example, the student model 130 may be trained by distillation using a stepwise loss function between intermediate output data of each model, so the performance and quality of the student model 130 may be equivalent to the teacher model 110.

Referring back to FIG. 2, the processor 106 of the learning device 100 may perform fine tuning on the student model 130 (S120).

The fine tuning may be processed, for example, using labeled ground truth data and pseudo ground truth data. The labeled ground truth data may be provided to be labeled in the format of 3D recognition data. The pseudo ground truth data may be 3D recognition data generated to be labeled by the teacher model 110.

For example, the ground truth data acquired in operation S105 may be the training data processed by a labeling task among a large number of BEV images. The BEV images that are not labeled may be discarded as they are not used as ground truth data. The image data and the 3D sensor data related to the unlabeled BEV image might not be used as input data for training. The image data and the 3D sensor data that might not be used as input data for training may be input to the trained teacher model 110, and 3D recognition data including a 3D bounding box and a class may be generated. The 3D recognition data generated from the teacher model 110 may be used as pseudo-ground truth data.

The loss used for the fine-tuning by the pseudo-ground truth data may be set to be less than the loss of the fine-tuning by the labeled ground truth data. For example, the loss function of the fine-tuning by the labeled ground truth data and the pseudo-ground truth data may be the same. In this case, the threshold value (or reference value) of the loss function according to the pseudo-ground truth data may be set to be less than the threshold value of the loss function according to the labeled ground truth data. For example, the threshold value of the loss function in the pseudo-ground truth data may be a value obtained by multiplying the threshold value of the labeled ground truth data by 0.1.

Operation S120 might not be necessarily performed, and the image processing network according to the student model 130 may be constructed in operation S115. When operation S120 may be performed, the student model 130 may be trained with a large amount of training data that may be greater than the ground truth data, so the performance of the student model 130 may be further improved.

Referring to FIG. 2, the processor 106 distributes the trained student model 130, that is, the image processing learning network that relies only on image sensor, to the vehicle 200, and the vehicle 200 may control the vehicle 200 using the student model 130 (S125).

Hereinafter, in FIG. 2, the vehicle 200 that receives the trained student model 130, that is, the image processing learning network that relies only on image sensor, from the learning device 100 and other devices that communicate with the device will be described.

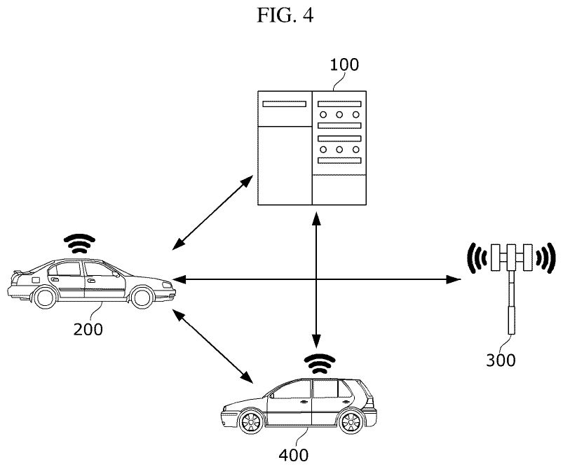

FIG. 4 may be a diagram illustrating a vehicle communicating with other devices to transmit and receive data.

As described above, the vehicle 200 may refer to a device that may move to a specific point. In the present disclosure, the vehicle 200 may be described as a vehicle that travels on the ground, but the present disclosure may also be applied to a mobility device for flying or water transportation. As described above regarding FIG. 1, the vehicle 200 may be controlled and driven autonomously, and the autonomous driving may be implemented as semi-autonomous driving or fully autonomous driving.

The vehicle 200 may be driven based on electrical energy or fossil energy. In the case of the electrical energy, the vehicle 200 may be, for example, a pure battery-based vehicle driven only by a high-voltage battery or a gas-based fuel cell as an energy source. In addition, the fuel cell may utilize various forms of gas that may generate electrical energy, and the gas may be, for example, hydrogen. However, the present disclosure may be not limited thereto, and various fuels/energy sources may be applied. In the case of fossil energy, the vehicle 200 may be driven based on fuel such as gasoline, diesel, or liquefied gas, and may be equipped with an engine that drives wheels included in an actuating unit 216 by combustion of the fuel. The engine may be included in a power source unit 214 from the perspective of providing the driving rotational power of the wheels to the actuating unit 216. As another example, the vehicle 200 may be driven in a hybrid manner using electrical energy and fossil energy.

The vehicle 200 may communicate with other devices 100 and 300 or other vehicles 400. The other devices may include, for example, a learning device 100 that supports various controls, status management, and driving of the vehicle 200, an ITS device 300 for receiving information from an ITS, various types of user devices, etc. The learning device 100 may be, for example, an external device operated by a vehicle manufacturer or a management agency providing autonomous driving services, as described above in FIG. 1.

The ITS device 300 may be, for example, a road side base station (RSU), and the ITS device 300 may exchange vehicle recognition data, driving control and state data, environmental data around the vehicle, map data, etc., with the vehicle 200 through vehicle-to-infrastructure (V2I) communication to assist the user's own driving or support the autonomous driving of the vehicle 200. The vehicle 200 may exchange the data listed above with another vehicle 400 through vehicle-to-vehicle (V2V) communication to support manual driving or autonomous driving.

The vehicle 200 may communicate with another vehicle or another device based on cellular communication, wireless access in vehicular environment (WAVE) communication, dedicated short range communication (DSRC) or short-range communication, or other communication methods.

For example, the vehicle 200 may use a cellular communication network such as long-term evolution (LTE), 5th generation (5G), wireless fidelity (WiFi), or WAVE for communication with the learning device 100, the ITS device 300, and other vehicles 400. As another example, DSRC, etc., used in the vehicle 200 may be used for communication between vehicles. The communication method between the vehicle 200, the learning device 100, the ITS device 300, other vehicles 400, and the user devices may be not limited to the above-described example.

FIG. 5 may be a diagram schematically illustrating modules that constitute a vehicle according to the present disclosure. The vehicle 200 of FIG. 5 exemplifies a ground vehicle.

The vehicle 200 may include a sensor unit 202, a manipulation unit 206, a display 208, a load device 210, and/or a transceiver 212.

The sensor unit 202 may include various types of sensors to detect various states and situations occurring in an external surrounding environment, internal system, a user operation, and a boarding space of the vehicle 200.

The sensor unit 202 may include, for example, an externally-oriented image sensor 204a, a radar sensor 204b, etc., to recognize dynamic and static objects existing around the vehicle 200.

The image sensor 204a may recognize an external object as an image while the vehicle 200 may be being used, generate image data, and transmit the image data to a processor 220. The image sensor 204a may be installed in multiple parts of the vehicle 200, so multiple images or multi-views of the surrounding environment of the vehicle 200 may be acquired.

The radar sensor 204b may emit radio waves of a specific frequency around the vehicle 200 to detect the presence of external objects and their relative distances, speeds, directions, etc., and generate radar data through the radio waves reflected from the external objects. Although a LiDAR sensor (not illustrated) may be not mounted in the present disclosure, in another example, the LiDAR sensor may be mounted on the vehicle 200.

The sensor unit 202 may include an attitude sensor 104c. The attitude sensor 104c may detect, for example, a three-axis state of the vehicle 200, for example, yaw, pitch, and roll, and output various vehicle attitude states based on the above-described factors. The attitude sensor may be composed of, for example, an inertial measurement unit (IMU) sensor, a gyro sensor, etc. The processor 220 may generate attitude data based on the attitude state.

In addition, the sensor unit 202 may include a positioning sensor 104d for confirming the position of the vehicle 200. The positioning sensor 104d is, for example, a global positioning system (GPS) sensor or a global navigation satellite system (GNSS) sensor but may be not limited thereto.

In the present disclosure, the sensors of the sensor unit 202 referred to in the description of the example are mainly described, and sensors that detect various situations not listed herein may be additionally included.

The manipulation unit 206 may be formed as a module for a user to control driving. For example, the manipulation unit 206 may be a steering wheel for manual driving, an automatic or manual transmission actuator, an accelerator pedal, a brake pedal, a gear shift, etc. The manipulation unit 206 may further be provided with an interface for the use, release, and selection of detailed functions of the autonomous driving mode requested by the user so that the user may use the autonomous driving function.

The display 208 may function as a user interface. The display 208 may be controlled by the processor 220 to display an operation state, a control state, route/traffic information, remaining energy information, content requested by a driver of the vehicle 200, etc. In addition, the display 208 may be formed as a touch screen capable of detecting a driver's input, so the display 108 may receive a driver's request that instructs the processor 220.

The load device 210 may be mounted on the vehicle 200 and may be a type of non-driving electric device excluding a driving power system such as the wheel driving unit (not illustrated). The load device 210 may be an auxiliary device that receives power from the power source unit 214, and may be, for example, an air conditioning system, an indicator lamp system, a lighting system, a seat system, various devices installed in the vehicle 200, etc.

The transceiver 212 may support mutual communication with the server 200, the ITS device 300, the nearby vehicle 400, etc. The transceiver 212 may include a module that processes, for example, cellular communication, WAVE communication, DSRC, etc. In the present disclosure, the transceiver 212 may transmit data generated or stored during driving to the server 200 and receive data and software modules transmitted from the server 200. The transceiver 212 may also support communication with an electronic device carried by a passenger inside the vehicle 200.

In addition, the vehicle 200 may include the power source unit 214 and the actuating unit 216.

The power source unit 214 may generate and supply power and electric power used in the driving power system such as the actuating unit 216 and the non-driving power system. The non-driving power system may be, for example, the sensor unit 202, the manipulation unit 206, the display 208, the load device 210, the transceiver 212, etc., and may be not limited thereto, and may include various components that implement sensing, interface, communication, and convenience functions, excluding components directly involved in driving operations.

When the vehicle 200 is driven based on electrical energy, the power source unit 214 may be composed of, for example, an electric battery that may be charged from the outside, or a combination of the electric battery and a fuel cell that charges the battery. In the case of a combination of the electric battery and the fuel cell, the power source unit 214 may include a tank that stores a material used to produce power for the fuel cell, for example, liquefied hydrogen. When the vehicle 200 may be driven based on fossil energy, the power source unit 214 may be composed of an internal combustion engine. In addition, when the vehicle 200 may be a hybrid type, the power source unit 214 may be provided as a combination of an internal combustion engine and an electric battery.

The actuating unit 216 has at least one module that implements a driving operation, and may perform at least one driving operation among longitudinal control such as acceleration/deceleration, lateral control such as steering, and gear shifting according to a user request from the manipulation unit 206 or a request from the processor 220. Here, the gear shifting may be processed by a manual driving user using a gear transmission or by a request from the processor 220 in autonomous driving.

The actuating unit 216 may include a wheel driving unit (not illustrated), a mechanical component for implementing a driving operation in the wheel driving unit, and an electronic module for executing the driving operation according to a command of the processor 220 by the user's manual operation or autonomous driving. When the vehicle 200 may be operated based on electrical energy, the vehicle 200 may include an assembly for transmitting the requested driving operation to the wheel driving unit. When the vehicle 200 may be operated based on fossil energy, the actuating unit 216 may include a transmission and a gear module that transmit the power of the internal combustion engine.

The wheel driving unit may include a plurality of wheels, a driving force generation module for generating and applying a driving force to the wheels or transmitting the driving force, a braking module for decelerating the driving of the wheels, and a steering module for realizing lateral control of the wheels. When the vehicle 200 may be driven based on electrical energy, the driving force generation module may be formed as a motor assembly that generates a driving force based on the power output from the electric battery. The braking module of the electric-based vehicle 200 may further have a regenerative braking function.

In addition, the vehicle 200 may include a memory 218 and the processor 220.

The memory 218 may store an application and various types of data for controlling the vehicle 200 and may load the application or read and record the data at the request of the processor 220. In the present disclosure, the memory 218 may receive and manage a trained image processing learning network from the learning device 100. In addition, the memory 218 may also receive and manage information necessary for driving, such as map information, traffic information, weather information, and accident information.

The processor 220 may perform the overall control of the vehicle 200. The processor 220 may be configured to execute applications and instructions stored in the memory 218. The processor 220 may generate 3D recognition data based on the image data acquired from the image sensor 204a using an image processing learning network corresponding to the student model 130. The image processing learning network may be a network utilized for vehicle control or vehicle driving, such as an object detection model, a semantic segmentation model, or a depth estimation model. In this way, the detection of the object in the image, the object occupancy information, and the depth information may be inferred. The processor 220 may control autonomous driving based on the estimated or inferred information. In addition, the processor 220 may perform autonomous driving control based on information estimated from an image, together with various types of data recognized from the radar sensor 204b, the attitude sensor 204c, and the positioning sensor 204d.

In the present disclosure, the processor 220 may be implemented as a single processing module, for example. In another example, the processing according to the above-described matters may be processed in a plurality of processing modules in a distributed manner, and the processor 220 may be collectively referred to as a plurality of processing modules in the present disclosure.

According to the present disclosure, by distilling a high-performance learning network that recognizes objects by fusing an image sensor and a three-dimensional (3D) recognition sensor and constructing an image-based learning network that relies only on an image sensor, a method and device for learning image processing for providing an image sensor-based learning network having the same performance as a high-performance learning network can be provided.

Effects which can be achieved by the present disclosure are not limited to the above-described effects. That is, other objects that are not described may be obviously understood by those skilled in the art to which the present disclosure pertains from the following description.

While the illustrative methods of the present disclosure described above are represented as a series of operations for clarity of description, it may be not intended to limit the order in which the steps are performed, and the steps may be performed simultaneously or in different order as necessary. The described steps may further include other steps, may include remaining steps except for some of the steps, or may include other additional steps except for some of the steps.

The various examples of the present disclosure are not a list of all possible combinations and are intended to describe representative aspects of the present disclosure, and the matters described in the various examples may be applied independently or in combination of two or more.

In addition, various examples of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method of learning image processing using knowledge distillation, the method comprising:
training, based on image data of an image sensor and three-dimensional (3D) sensor data of a 3D recognition sensor different from the image sensor, a teacher model comprising a first learning network, wherein the teacher model is configured to generate 3D recognition data for recognizing an object three-dimensionally, and wherein the teacher model is trained to:
generate, based on a fused feature that is based on a feature of the image data and a feature of the 3D sensor data, a teacher 3D recognition feature, and
generate the 3D recognition data by decoding the teacher 3D recognition feature; and
training, based on the image data by the knowledge distillation of the teacher model, a student model comprising a second learning network, wherein the student model is configured to generate 3D recognition data by:
generating a student 3D recognition feature based on a student image feature of the image data, and
decoding the student 3D recognition feature,
wherein the training of the student model includes training the student model using a first loss between the fused feature and the student image feature and a second loss between the teacher 3D recognition feature and the student 3D recognition feature.

2. The method of claim 1, wherein a dimension of the fused feature is set to be the same as a dimension of the student image feature.

3. The method of claim 1, wherein the 3D sensor data is preprocessed to:
arrange point information of the 3D sensor data to a position occupied in a two-dimensional (2D) space centered on a device in which the image sensor is mounted, and
encode data that is not provided in 2D image data among the point information to the position.

4. The method of claim 3, wherein the feature of the image data is mapped to the 2D space by a geometric parameter of the image sensor.

5. The method of claim 1, wherein the student image feature is extracted using an encoder having lower performance than an encoder that generates the feature of the image data.

6. The method of claim 1, wherein the student image feature is generated to be mapped to the same space as a 2D space occupied by the 3D sensor data by a geometric parameter of the image sensor.

7. The method of claim 1, wherein the training the student model comprises transferring a decoder that decodes the teacher 3D recognition feature to a decoder that decodes the student 3D recognition feature.

8. The method of claim 1, wherein the first loss is established based on an identity between the fused feature and the student image feature, and wherein the second loss is established based on an identity between the teacher 3D recognition feature and the student 3D recognition feature.

9. The method of claim 1, further comprising:
after the training of the student model, performing fine tuning on the student model by processing the fine tuning using labeled ground truth data and pseudo ground truth data, wherein the labeled ground truth data is provided to be labeled in a format of the 3D recognition data, wherein the pseudo ground truth data is the 3D recognition data generated to be labeled by the teacher model, and wherein a loss used for the fine tuning by the pseudo ground truth data is set to be less than a loss of the fine tuning by the labeled ground truth data.

10. The method of claim 1, wherein the 3D recognition sensor includes at least one of a light detection and ranging (LiDAR) sensor, a radar sensor, or an ultrasonic sensor.

11. A device for learning image processing using knowledge distillation, the device comprising:
one or more processors; and
memory storing instructions that, when executed by the one or more processors, cause the device to:
train, based on image data of an image sensor and three-dimensional (3D) sensor data of a three-dimensional recognition sensor different from the image sensor, a teacher model comprising a first learning network, wherein the teacher model is configured to generate 3D recognition data for recognizing an object three-dimensionally, and wherein the teacher model is trained to:
generate, based on a fused feature that is based on a feature of the image data and a feature of the 3D sensor data, a teacher 3D recognition feature, and
generate the 3D recognition data by decoding the teacher 3D recognition feature, and
train, based on the image data by the knowledge distillation of the teacher model, a student model comprising a second learning network, wherein the student model is configured to:
generate 3D recognition data by:
generating a student 3D recognition feature based on a student image feature of the image data, and
decoding the student 3D recognition feature,
wherein the training of the student model includes training the student model using a first loss between the fused feature and the student image feature and a second loss between the teacher 3D recognition feature and the student 3D recognition feature.

12. The device of claim 11, wherein a dimension of the fused feature is set to be the same as a dimension of the student image feature.

13. The device of claim 11, wherein the 3D sensor data is preprocessed to:
arrange point information of the 3D sensor data to a position occupied in a two-dimensional (2D) space centered on a device in which the image sensor is mounted, and
encode data that is not provided in 2D image data among the point information to the position.

14. The device of claim 13, wherein the feature of the image data is mapped to the 2D space by a geometric parameter of the image sensor.

15. The device of claim 11, wherein the student image feature is extracted using an encoder having lower performance than an encoder that generates the feature of the image data.

16. The device of claim 11, wherein the student image feature is generated to be mapped to the same space as a 2D space occupied by the 3D sensor data by a geometric parameter of the image sensor.

17. The device of claim 11, wherein the instructions, when executed by the one or more processors, cause the device to train the student model by causing the device to transfer a decoder that decodes the teacher 3D recognition feature to a decoder that decodes the student 3D recognition feature.

18. The device of claim 11, wherein the first loss is established based on an identity between the fused feature and the student image feature, and wherein the second loss is established based on an identity between the teacher 3D recognition feature and the student 3D recognition feature.

19. The device of claim 11, wherein the instructions, when executed by the one or more processors, further cause the device to:
after the training of the student model, perform fine-tuning on the student model by processing the fine tuning using labeled ground truth data and pseudo ground truth data, wherein the labeled ground truth data is provided to be labeled in a format of the 3D recognition data, wherein the pseudo ground truth data is the 3D recognition data generated to be labeled by the teacher model, and wherein a loss used for the fine tuning by the pseudo ground truth data is set to be less than a loss of the fine tuning by the labeled ground truth data.

20. A computing device configured to use machine learning to perform image processing using knowledge distillation, the computing device comprising:
one or more processors; and
memory storing instructions that, when executed by the one or more processors, cause the device to:
train, based on image data of an image sensor and three-dimensional (3D) sensor data of a three-dimensional recognition sensor different from the image sensor, a teacher model comprising a first learning network, wherein the teacher model is configured to generate three-dimensional recognition data for recognizing an object three-dimensionally;
train, based on the image data by the knowledge distillation of the teacher model, a student model comprising a second learning network;
provide, as input to the teacher model, a fused feature that is based on a feature of the image data and a feature of the 3D sensor data;
receive, as output from the teacher model, a teacher 3D recognition feature;
generate first 3D recognition data by decoding the teacher 3D recognition feature;
provide, to the student model, a student image feature of the image data;
receive, as output from the student model a student 3D recognition feature;
generate second 3D recognition data by processing the student 3D recognition feature; and
further train the student model based on:
a first loss between the fused feature and the student image feature, and
a second loss between the teacher 3D recognition feature and the student 3D recognition feature.
